(19) United States
(12) Patent Application Publication
(10) Pub. No.: US 2017/0367273 A1
(43) Pub. Date: Dec. 28, 2017

(54) Devices and Methods for Illuminating Plants

(71) Applicant: Ryan Bylsma, Grand Rapids, MI (US)

(72) Inventor: Ryan Bylsma, Grand Rapids, MI (US)

(21) Appl. No.: 15/631,326

(22) Filed: Jun. 23, 2017

Related U.S. Application Data
(60) Provisional application No. 62/354,299, filed on Jun. 24, 2016.

(51) Int. Cl. A01G 7/04; A01G 9/20; F21V 3/02; F21V 3/04; F21V 7/22; F21Y 103/00; F21Y 2115/10

(52) U.S. Cl. CPC A01G 7/045; F21V 3/0409; A01G 9/20; F21V 7/22; F21V 3/02; F21Y 2115/10; F21Y 2103/00

(57) ABSTRACT

A plant illumination device may include an elongate body comprising: a light propagating section, a light quenching section coupled to a first end of the light propagating section, and, optionally, a light conducting apex coupled to a second end of the light propagating section. In some embodiments, the light conducting apex acquires light which propagates to the light propagating section. The light propagating section may be positioned in proximity to a non-root portion of a plant and the light quenching section in proximity to a root system of the plant. In some embodiments, the light is prevented from reaching the root system of the plant by the light quenching section. In some embodiments, the light includes sunlight, green light, or red light.

### CROSS-REFERENCE TO RELATED APPLICATIONS

This application claims the benefit of U.S. Provisional Patent Appl. Ser. No. 62/354,299, filed Jun. 24, 2016, entitled “Devices and Methods for Illuminating Plants,” the disclosure of which is incorporated by reference in its entirety.

### TECHNICAL FIELD

This disclosure relates generally to the fields of agriculture and/or horticulture, and more specifically to devices and methods for illuminating plants.

### BACKGROUND

The world needs to produce at least 50% more food to feed nine billion people by 2050. Current systems and devices to improve plant propagation rely on fertilizers, overhead lighting systems to increase photosynthesis, and/or genetic modification. Fertilizers are often toxic to the surrounding environment and expensive for regular use. Genetic modification may provide short-term sustainability, but the long-term effects of genetic modification are unknown or unclear both from a human consumption and environmental impact perspective. Further, overhead lighting systems, while non-toxic and affordable, do not distribute light sufficiently over the entirety of the plant.

Thus, there is a need for new and useful devices and methods for illuminating plants. This disclosure provides such new and useful devices and methods.

### SUMMARY

Described herein are devices and methods for improving growth of plants. One aspect of the present disclosure is directed to a plant illumination device. In some embodiments, the plant illumination device includes: an elongate body including a light conducting apex, a light propagating section coupled to the light conducting apex, and a light quenching section coupled to the light propagating section. In some embodiments, the light conducting apex acquires light which propagates to the light propagating section. In some embodiments, the light propagating section is adjacent to a non-root portion of a plant and the light quenching section is adjacent to a root system of the plant. In some embodiments, the light is prevented from reaching the root system of the plant by the light quenching section.

In some embodiments, the light propagating section includes a planar edge opposite a convex surface. In some embodiments, the planar edge is configured for coupling to the non-root portion of the plant.

In some embodiments, a length of the elongate body depends on a height of the plant.

In some embodiments, the light propagating section further includes a light source. In some embodiments, the light source is a light-emitting diode.

In some embodiments, the light propagating section includes or is formed of a light propagating material. In some embodiments, the light propagating material includes or is formed of rutile.

In some embodiments, a base of the light quenching section includes or is formed of a reflective material so that light propagating into the light quenching section is reflected back to the light propagating section. In some embodiments, the reflective material includes one or more of: mylar, foylon, glass, metal, lacquer, enamel, and a combination thereof.

Another aspect of the present disclosure is directed to a elongate device for illuminating a portion of a plant. In some embodiments, the device includes: a first end shaped for gathering light; a second end coated with a reflective material; and a mid-section positioned between and coupled to the first and second ends. In some embodiments, the light gathered by the tip is propagated to the mid-section. In some embodiments, the mid-section includes a material for propagating the light out of the device and onto a non-root portion of the plant. In some embodiments, the reflective material coating the second end reflects the light into the mid-section and the first end and prevents a root system of the plant from light exposure.

In some embodiments, the mid-section includes a planar edge opposite a convex surface. In some embodiments, the planar edge is configured for coupling to the non-root portion of the plant.

In some embodiments, a length of the elongate device depends on a height of the plant.

In some embodiments, the mid-section further includes a light source. In some embodiments, the light source is a light-emitting diode.

In some embodiments, the material of the mid-section includes or is formed of rutile.

In some embodiments, a base of the second end includes or is formed of a reflective material so that light propagating into the second end is reflected back to the mid-section. In some embodiments, the reflective material includes or is formed of metal. In some embodiments, the reflective material coating the second end includes or is formed of one or more of: mylar, foylon, glass, metal, lacquer, enamel, and a combination thereof.

### BRIEF DESCRIPTION OF THE DRAWINGS

FIG. 1A illustrates a side view of one embodiment of a plant illumination device.

FIG. 1B illustrates a side view of one embodiment of a plant illumination device.

FIG. 2 schematically illustrates propagation of light through and out of one embodiment of a plant illumination device.

FIG. 3 illustrates a top view of one embodiment of a plant illumination device.

FIG. 4 illustrates a side view of one embodiment of a plant illumination device.

FIG. 5 illustrates light propagation through one embodiment of a plant illumination device.

FIG. 6A illustrates one embodiment of a use of a plant illumination.

FIG. 6B illustrates one embodiment of a use of a plant illumination device.

FIG. 7 shows a flow chart of one embodiment of a method of using a plant illumination device.

### DETAILED DESCRIPTION

The foregoing is a summary, and thus, necessarily limited in detail. The above mentioned aspects, as well as other aspects, features, and advantages of the present technology will now be described in connection with various embodiments. The inclusion of the following embodiments is not intended to limit the invention to these embodiments, but rather to enable any person skilled in the art to make and use contemplations of the invention(s). Other embodiments may be utilized and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

Disclosed herein are devices and methods for illuminating plants. As described herein, a “user” of the device refers to any person capable of, interested in, planning on, or currently propagating or growing plants. A user includes a farmer, horticulturalist, agriculturalist, plant enthusiast, botanist, environmentalist, conservationist, biologist, groundskeeper, florist, arborculturalist, viticulturalist, viniculturalist, a grower of Cannabis, or any other person involved in the planting, sowing, growing, propagating, reaping, and/or harvesting of plants.

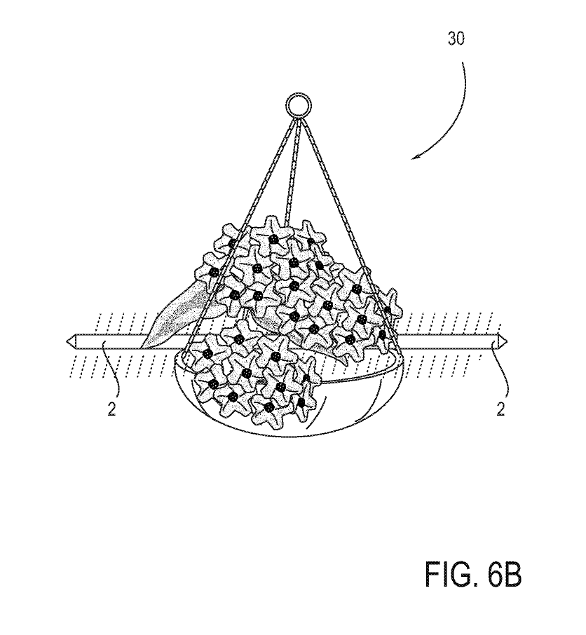

As used herein, a “plant” refers to any genus, species, or varietal of plant. A plant may be terrestrial, freshwater aquatic, saline water aquatic, perennial, annual, tuber, or any other type of plant. A plant may be fruit bearing or not. The plant may be grown in the ground, in a pot 32 (FIG. 6A), hanging planter 30 (e.g., pot, basket, biodegradable material, etc., example shown in FIG. 6B), or any other type of device or in any location.

As used herein, “light” refers to any source of natural or artificial light. The light may be harvested from the sun or a light source (e.g., incandescent bulb, light-emitting diode (LED), organic LED, fluorescent tube, etc.). The light may include visible, near ultraviolet, near infrared, mid infrared, or far infrared light. The light may be in the “green” range: 495 nm to 570 nm. The light may be in the “red” range: 620 nm to 750 nm.

### DEVICES

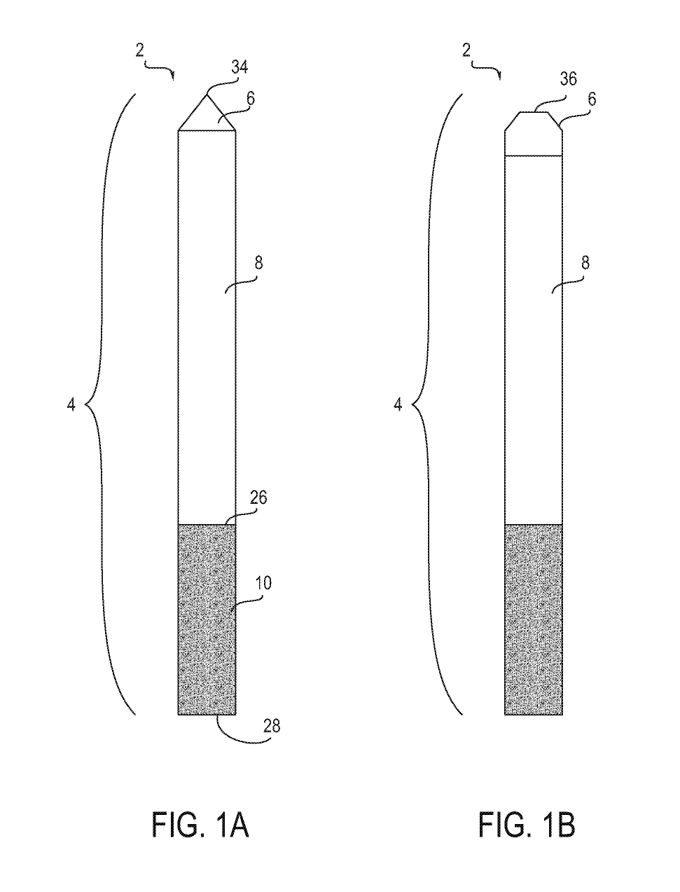

As shown in FIG. 1A and FIG. 1B, a plant illumination device 2 includes an elongate body 4 including a light propagating section 8 and a light quenching section 10 coupled to the light propagating section 8. The device 2 functions to distribute light across a plant's surface, along a length or height of a plant, and/or around a plant. For example, the device 2 may function to improve growth or propagation of a plant during an “on-cycle” or “day cycle” of the plant and/or to improve visualization of a plant during an “off-cycle” or “night cycle” of the plant.

As shown in FIG. 1A and FIG. 1B, a plant illumination device 2 includes an elongate body 4. The elongate body 4 functions to provide support to a plant and/or distribute light across a plant's surface, along a length or height of a plant, and/or around a plant. In some embodiments, the elongate body 4 may include one or more regions including a synthetic or semi-synthetic material. In some embodiments, the elongate body 4 may be formed of one or more transparent or semi-transparent regions, for example to enable collected light to leave or reflect from the device. For example, the elongate body 4 may include or be formed of acrylic, polyethylene terephthalate, polyethylene, high-density polyethylene, polyvinyl chloride, polyvinylidene chloride, low-density polyethylene, polypropylene, polystyrene, and/or any other plastic based material. In some embodiments, the elongate body 4 may include or be formed of glass. For example, the elongate body 4 may include or be formed of borosilicate glass, soda-lime silicate glass, phosphate-based glass, and/or any other type of glass. In some embodiments, two or more materials may be combined, for example using two shot injection molding or any other type of manufacturing process.

The elongate body 4 may be sized and/or shaped to match or complement a size, height, length, and/or shape of a plant. The elongate body 4 may be short, intermediate in length, or long. In some embodiments, the elongate body 4 may be two inches to fifteen feet. In one embodiment, the elongate body 4 is one foot to ten feet. In one embodiment, the elongate body 4 is six inches to five feet. In one embodiment, the elongate body 4 is five feet to seven feet. In some embodiments, the elongate body 4 is 3, 4, 5, or 6 feet in length. The elongate body 4 may have any range of diameters. For example, the diameter of the elongate body 4 may be one inch to one foot. In one embodiment, the diameter is 1, 2, 3, 4, 5, 6, 7, 8, 9, or 10 inches. In one embodiment, the diameter is 0.5, 1.5, 2.5, 3.5, 4.5, 5.5, 6.5, 7.5, 8.5, 9.5, or 10.5 inches. In one embodiment, the diameter is 0.25 inches. In one embodiment, the diameter is 0.75 inches. In one embodiment, the diameter is 0.33 inches.

The elongate body 4 may be linear, curved, bent, or any configuration or shape suitable for improving plant growth, supporting a plant, and/or illuminating a plant. In some embodiments, the elongate body 4 may be tubular, triangular, cuboidal, or any other shape. The elongate body 4 may be hollow or solid.

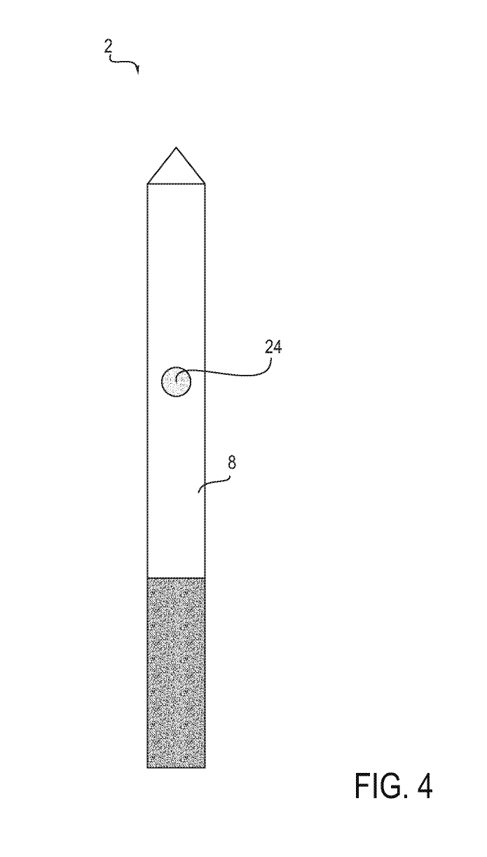

In some embodiments, as shown in FIG. 3, the elongate body 4 optionally includes a planar, flat, straight, or otherwise uncurved edge, side, or surface 20 opposite a convex, beveled, or otherwise curved side or surface 22. The planar, flat, or straight edge 20 functions to improve positioning of the elongate body 4 close to a plant stem or trunk and/or to improve coupling (e.g., tying, tethering, etc.) of the elongate body 4 to the plant stem or trunk.

Returning to FIG. 1A and FIG. 1B, in some embodiments, a plant illumination device includes a light propagating section 8. The light propagating section 8 functions to acquire light and disperse or dispense the light to a non-root portion of the plant. In some embodiments, for example in the absence of a light conducting apex or tip, the light propagating section conducts light. For example, the light may be sunlight to improve growth or propagation of the plant or “green light” to improve visualization of the plant during “off-cycle” or night (i.e., dark) hours. In some embodiments, the light propagating section is positioned in the middle or in a mid-section of the device, at one or more ends of the device, or at any position along the length of the elongate body 4. In one non-limiting embodiment, the light propagating section is positioned in the middle or mid-section of the device. The light propagating section 8 is in proximity, adjacent to, or next to a non-root portion (e.g., stem, trunk) portion of a plant. Further, the light propagating section may be coupled to a tip or light conducting apex 6, as described elsewhere herein.

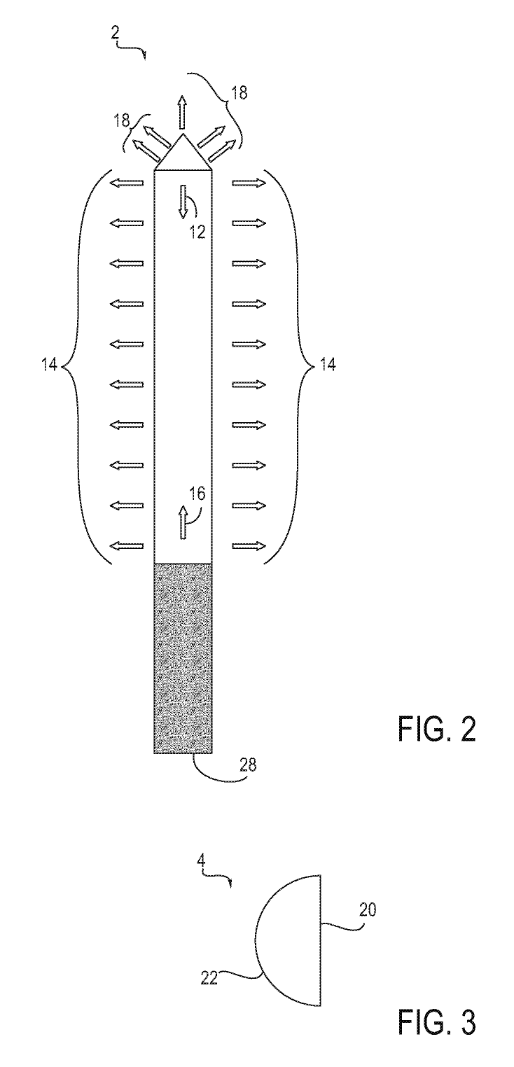

In some embodiments, the light propagating section 8 may include or be formed of a synthetic or semi-synthetic material. In some embodiments, the light propagating section 8 may be transparent or semi-transparent to allow, for example light to transmit out of, disperse from, or otherwise leave the light propagating section to promote growth of a non-root portion of the plant, as shown by light propagating arrows 14 in FIG. 2. For example, the light propagating section 8 may include or be formed of acrylic, polyethylene terephthalate, polyethylene, high-density polyethylene, polyvinyl chloride, polyvinylidene chloride, low-density polyethylene, polypropylene, polystyrene, or any other plastic based material. In some embodiments, the light propagating section 8 may include or be formed of glass. For example, the light propagating section 8 may include or be formed of borosilicate glass, soda-lime silicate glass, phosphate-based glass, and/or any other type of glass. In some embodiments, the light propagating section 8 further includes or is formed of a light propagating material, for example titanium dioxide (e.g., tetragonal, orthorhombic, monoclinic, or cubic in structure), rutile, ilmenite, and/or anatase (i.e., octahedrite). In one non-limiting embodiment, the light propagating material includes rutile. In another non-limiting embodiment, the light propagating material includes titanium dioxide.

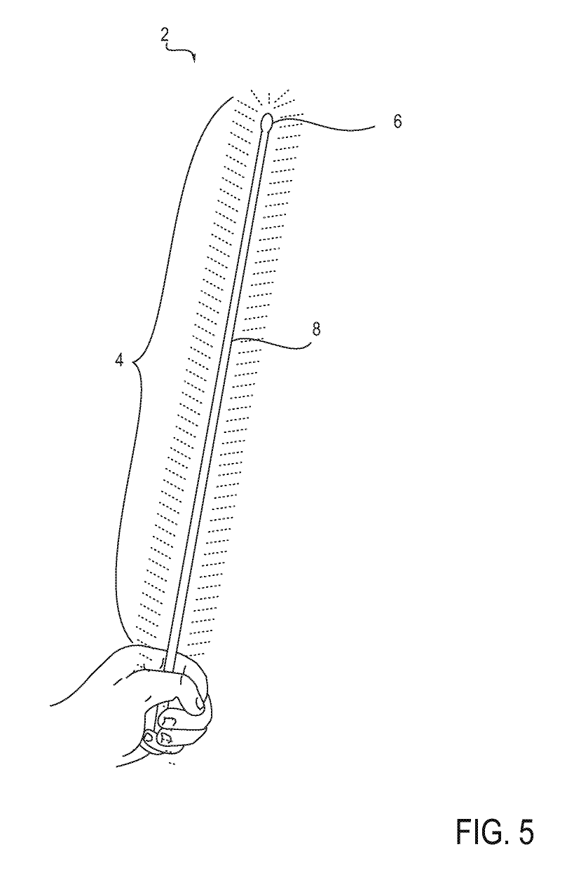

In some embodiments, as shown in FIG. 4, the light propagating section 8 further includes a light source 24. For example, the light source may be a light emitting diode (LED), an organic LED, an incandescent bulb, a fluorescent tube, an ultraviolet light emitting bulb or tube, or any other type of light source. In one non-limiting embodiment, the light source 24 is an LED.

Returning to FIG. 1A and FIG. 1B, in some embodiments, a plant illumination device 2 includes a light quenching section 10 coupled to the light propagating section 8. The light quenching section 10 functions to prevent light from reaching a root system of a plant. The light quenching section may be positioned on one or more ends (e.g., first or second end) of the elongate body 4, in a middle or mid-section of the elongate body 4 (e.g., if the device is in a hanging planter 30, non-root portions may extend from one or more sides of the hanging planter, as shown in FIG. 6B), or anywhere along the length of the elongate body 4. The light quenching section 10 is in proximity to, adjacent to, next to, or otherwise near a root system of the plant. The root system may be in a growth media (e.g., top soil, dirt, water, fertilizer, etc.) surrounding the plant. In some embodiments, the light quenching section 10 includes a reflective material, for example mylar, foylon, glass, metal, lacquer, and/or enamel, so that light propagating into the light quenching section is reflected back to the light propagating section, as shown by light propagation arrows 16 in FIG. 2. In one non-limiting embodiment, the reflective material includes mylar. In another non-limiting embodiment, the reflective material includes metal.

In some embodiments, as shown in FIG. 1A, a first end 26 of the light quenching section 10 is coupled to the light propagating section 8 and a second end 28 of the light quenching section comprises a base, planar surface, or flat surface. The base comprises a reflective material so that light propagating into the light quenching section is reflected back to the light propagating section, as shown by light propagating arrows 16 in FIG. 2. In some embodiments, the reflective material on the base includes mylar, foylon, glass, metal, lacquer, and/or enamel. In one non-limiting embodiment, the reflective material includes mylar. In another non-limiting embodiment, the reflective material includes metal.

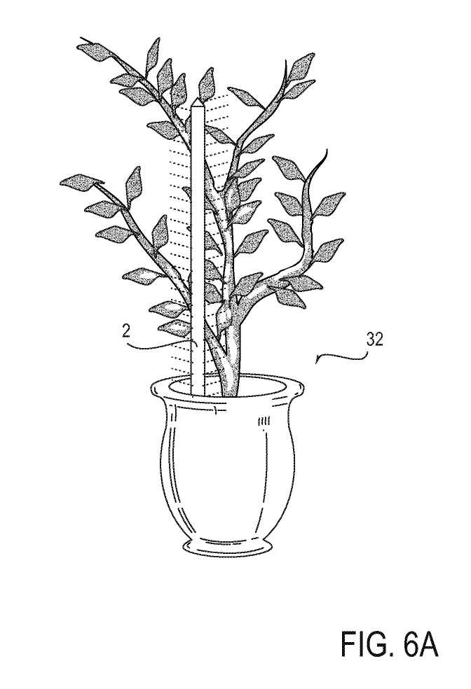

In some embodiments, as shown in FIG. 1A and FIG. 1B, a plant illumination device optionally includes a first end comprising a tip shaped for conducting light or a light conducting apex 6. The tip or light conducting apex 6 functions to acquire, collect, or otherwise gather light (e.g., sunlight, ultraviolet light, green lights, red light, etc.) that is propagated through the elongate body 4. Light shining on the tip or light conducting apex 6 may be concentrated and propagated or reflected into a light propagating section 8 of the elongate body 4, as shown in FIG. 5 and by light propagating arrow 12 in FIG. 2. The light may also disperse or radiate from the tip or apex 6, as shown in FIG. 5 and by light propagating arrows 18 in FIG. 2. In some embodiments, the tip or apex may comprise a synthetic or semi-synthetic material. Additionally or alternatively, the tip or apex 6 may be transparent or semi-transparent, for example to acquire, transmit, and/or disperse light. For example, the tip or apex 6 may include acrylic, polyethylene terephthalate, polyethylene, high-density polyethylene, polyvinyl chloride, polyvinylidene chloride, low-density polyethylene, polypropylene, polystyrene, or any other plastic based material. In some embodiments, the tip or apex 6 may include glass. For example, the tip or apex 6 may include borosilicate glass, soda-lime silicate glass, phosphate based glass, and/or any other type of glass.

In some embodiments, the light conducting apex 6 may be sized and shaped to effectively collect, transmit, and/or disperse light. As shown in FIG. 1A, in one embodiment, the light conducting apex may include a tip or pointed end 34. As shown in FIG. 1B, in one embodiment, the light conducting apex may include a flat, rounded, or planar end 36.

In some embodiments, the light conducting apex or tip 6 may be reversibly or irreversibly coupled to the light propagating section 8 and/or the light quenching section 10. In some embodiments, the light propagating section 8 may be reversibly or irreversibly coupled to the light quenching section 10. In some embodiments, a reversible coupling includes a hinge, screw connection, magnetic coupling, snap-fit connection, adhesive or other type of fastener or coupling. A reversible coupling, may enable a user of the device to rearrange segments or portions of the elongate body. In some embodiments, two or more sections are fused or manufactured as irreversibly coupled components, for example two portions, sections, or segments of one elongate body 4.

### Methods

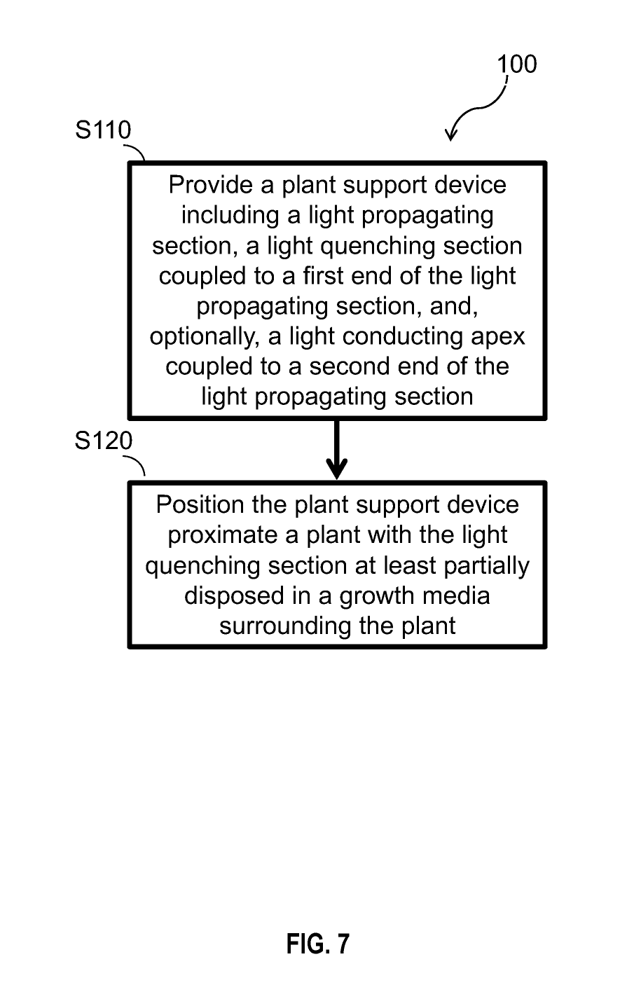

As shown in FIG. 7, one embodiment of a method 100 of using a plant illumination device includes providing a plant illumination device including a light propagating section, a light quenching section coupled to a first end of the light propagating section, and optionally a light conducting apex coupled to a second end of the light propagating section S110; and positioning the plant illumination device proximate a plant with the light quenching section at least partially disposed in a growth media surrounding the plant S120. In some embodiments, the method functions to promote, augment, and/or improve plant growth and/or propagation by increasing light availability and dispersion along a length of the plant, for example to increase photosynthesis. In some variations, the method functions to improve visualization of the plant during “off-cycle,” “night cycle,” or dark hours in which the plant is not undergoing substantial photosynthesis, for example to treat the plant with insecticides, fertilizer, and/or any other chemical or treatment.

As shown in FIG. 7, one embodiment of method 100 of using a plant illumination device includes block S110, which recites providing a plant illumination device including a light propagating section, a light quenching section coupled to a first end of the light propagating section, and optionally a light conducting apex coupled to a second end of the light propagating section. The device includes at least two sections: a light propagating section in proximity to a non-root portion of a plant and a light quenching section in proximity to a root portion or system of a plant. In some embodiments, the device further includes a light conducting apex or tip, as described elsewhere herein.

As shown in FIG. 7, one embodiment of a method 100 of using a plant illumination device includes block S120, which recites positioning the plant illumination device proximate a plant with the light quenching section at least partially disposed in a growth media surrounding the plant. Block S120 functions to promote growth of the non-root portion of the plant to increase photosynthesis and/or visualization of the plant while protecting the root system of the plant from light. The device may be positioned proximate the plant and supported, for example by the growth media surrounding the plant and/or by coupling e.g., tethering, fastening, tying, etc.) the device to the plant.

As used in the description and claims, the singular form “a”, “an” and “the” include both singular and plural references unless the context clearly dictates otherwise. For example, the term “a plant illumination device” may include, and is contemplated to include, a plurality of plant illumination devices. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device or substance.

As used herein, the term “comprising” or “comprises” is intended to mean that the devices and methods include the recited elements, and may additionally include any other elements. “Consisting essentially of” shall mean that the devices and methods include the recited elements and exclude other elements of essential significance to the combination for the stated purpose. Thus, a device or method consisting essentially of the elements as defined herein would not exclude other materials, features, or steps that do not materially affect the basic and novel characteristic(s) of the claimed invention(s). “Consisting of” shall mean that the devices and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A plant illumination device comprising:
an elongate body comprising:
a light conducting apex,
a light propagating section coupled to the light conducting apex, and
a light quenching section coupled to the light propagating section,
wherein the light conducting apex acquires light which propagates to the light propagating section,
wherein the light propagating section is adjacent to a non-root portion of a plant and the light quenching section is adjacent to a root system of the plant, and
wherein the light is prevented from reaching the root system of the plant by the light quenching section.

2. The device of claim 1, wherein the light propagating section comprises a planar edge opposite a convex surface.

3. The device of claim 2, wherein the planar edge is configured for coupling to the non-root portion of the plant.

4. The device of claim 1, wherein a length of the elongate body depends on a height of the plant.

5. The device of claim 1, wherein the light propagating section further comprises a light source.

6. The device of claim 5, wherein the light source is a light-emitting diode.

7. The device of claim 1, wherein the light propagating section comprises a light propagating material.

8. The device of claim 7, wherein the light propagating material comprises rutile.

9. The device of claim 1, wherein a base of the light quenching section comprises a reflective material so that light propagating into the light quenching section is reflected back to the light propagating section.

10. The device of claim 9, wherein the reflective material comprises one or more of: mylar, foylon, glass, metal, lacquer, enamel, and a combination thereof.

11. A elongate device for illuminating a portion of a plant, the device comprising:
a first end shaped for gathering light;
a second end coated with a reflective material; and
a mid-section positioned between and coupled to the first and second ends,
wherein the light gathered by the tip is propagated to the mid-section,
wherein the mid-section comprises a material for propagating the light out of the device and onto a non-root portion of the plant, and
wherein the reflective material coating the second end reflects the light into the mid-section and the first end and prevents a root system of the plant from light exposure.

12. The elongate device of claim 11, wherein the mid-section comprises a planar edge opposite a convex surface.

13. The elongate device of claim 12, wherein the planar edge is configured for coupling to the non-root portion of the plant.

14. The elongate device of claim 11, wherein a length of the elongate device depends on a height of the plant.

15. The elongate device of claim 11, wherein the mid-section further comprises a light source.

16. The elongate device of claim 15, wherein the light source is a light-emitting diode.

17. The elongate device of claim 11, wherein the material of the mid-section comprises rutile.

18. The elongate device of claim 11, wherein a base of the second end comprises a reflective material so that light propagating into the second end is reflected back to the mid-section.

19. The elongate device of claim 18, wherein the reflective material comprises metal.

20. The elongate device of claim 11, wherein the reflective material coating the second end comprises one or more of: mylar, foylon, glass, metal, lacquer, enamel, and a combination thereof.
